(19) United States
(12) Patent Application Publication
(10) Pub. No.: US 2013/0215106 A1
(43) Pub. Date: Aug. 22, 2013

(54) CURSOR MERGING DEVICE AND CURSOR MERGING METHOD

(71) Applicant: Atsushi YAMAGUCHI, Osaka (JP)

(72) Inventor: Atsushi YAMAGUCHI, Osaka (JP)

(73) Assignee: Panasonic Corporation, Osaka (JP)

(21) Appl. No.: 13/569,189

(22) Filed: Aug. 8, 2012

(30) Foreign Application Priority Data
Feb. 16, 2012 (JP) 2012-031277
Jul. 10, 2012 (JP) 2012-154890

(51) Int. Cl. G06T 15/00

(52) U.S. Cl. 345/419

(57) ABSTRACT

With a cursor merging device, an image parallax detector detects subject-use parallax information about a subject-use stereoscopic image indicated by cursor position information. A proper parallax range determination component sets a proper parallax range, which is the range of proper parallax. A cursor parallax production component sets cursor parallax information so that the parallax of a cursor is included in a proper parallax range. A cursor stereoscopic image production component produces a cursor-use stereoscopic image on the basis of cursor parallax information. A cursor stereoscopic image merging component 6 merges the cursor-use stereoscopic image included in the proper parallax range with a subject-use stereoscopic image.

### CROSS-REFERENCE TO RELATED APPLICATIONS

This application claims priority under 35 U.S.C. §119 to Japanese Patent Application No. 2012-031277, filed on Feb. 16, 2012 and No. 2012-154890, filed on July 10, 2012. The entire disclosure of Japanese Patent Application No. 2012-031277 and No. 2012-154890 are hereby incorporated herein by reference.

### BACKGROUND

1. Technical Field

The technology disclosed herein relates to a cursor merging device for merging the image of a cursor with a subject-use stereoscopic image including left and right images. The technology disclosed herein also relates to a cursor merging method in which a cursor merging device is used.

2. Background Information

Recent years have seen an increase in opportunities to screen a movie with a stereoscopic image including left and right images. There are also more opportunities to watch stereoscopic images at home by means of satellite broadcasts, Blu-ray discs, or other such packaged media.

A stereoscopic image is an image designed to look three-dimensional. The stereoscopic image is accomplished based on parallax between a left-eye image and a right-eye image. The observer feels the depth perception by seeing the stereoscopic image. The left-eye image is controlled so that it goes into only the left eye of the observer, and the right-eye image is controlled so that it goes into only the right eye of the observer. How the viewing of stereoscopic images relates to fatigue and to a sense of naturalness has been the subject of research in recent years. This has led to safety guidelines for the proper viewing of stereoscopic image, and safety is beginning to be taken into account in the production of stereoscopic images.

First, the principle behind a stereoscopic image will be described through reference to FIG. 6.

FIG. 6 is a simplified diagram illustrating the principle behind a stereoscopic image.

A stereoscopic image includes a pair of left and right images. As shown in FIG. 6, for example, a stereoscopic image is captured by two imaging devices used for the left eye (hereinafter referred to as L side) and the right eye (hereinafter referred to as R side). In FIG. 6, the left and right imaging devices are disposed so that they are separated by a specific distance (hereinafter referred to as the stereo base) and their optical axes intersect. The angle formed by the optical axes of the left and right imaging devices is called the convergence angle, and the position of intersection is called the reference plane. The stereo base is usually set to the spacing between the eyes of an average adult, such as about 65 mm. This spacing does not necessarily have to be used, however.

FIG. 6 shows how an apple (the subject) disposed in the middle of the two devices looks at different positions in the optical axis direction. FIG. 6A shows the situation in which the apple is in front of the reference plane. FIG. 6B shows the situation in which the apple lies on the reference plane. FIG. 6C shows the situation in which the apple is behind the reference plane.

As shown in FIG. 6A, when the apple is in front of the reference plane, the image on the L side shows the apple to the right of center, while the image on the R side shows the apple to the left of center. These L and R images are merged by the viewer's brain when perceived by the left and right eyes, and to the viewer the image appears to pop out to the front.

Also, as shown in FIG. 6B, when the apple lies in the reference plane, the L and R images both show the apple in the middle. In this case, when the brain merges the L and R images, it looks to the viewer as though the apple is in the reference plane position, that is, in the position of the display device.

Furthermore, as shown in FIG. 6C, when the apple is behind the reference plane, the image on the L side shows the apple to the left of center, while the image on the R side shows the image to the right of center. These L and R images are merged by the viewer's brain when perceived by the left and right eyes, and to the viewer the image appears farther away.

The important point here is that the positions where the subject is shown in the L side image and the R side image vary with the relative positional relation between the subject and the reference plane position. The position difference between the L side image and the R side image is called parallax. The relation between the amount of parallax and unnaturalness or fatigue when a stereoscopic image is viewed has become clear in recent years. Too much parallax is a cause of unnaturalness or fatigue, and guidelines have been provided for the safe amount of parallax.

For example, according to the 3D Consortium Safety Guidelines, the suggested parallax angle of the fusion limit of a stereoscopic image is about 2 degrees, while the suggested comfortable parallax is a parallax angle of 1 degree or less. As to the parallax limit in the divergence direction, it is preferable if the depth parallax on a display does not exceed the interpupillary distance. When children are taken into consideration, it is preferable to avoid parallax that is over 50 mm.

FIG. 7 illustrates the parallax angle and depth parallax.

The parallax angle is an angle of θ−α or β−θ in FIG. 7. The range in which these parallax angles are 1 degree or less is the comfortable parallax range. For example, with a displaying having an aspect ratio of 16:9, if we assume that a worker is watching a stereoscopic image from a distance of three times the screen height, then this parallax angle of 1 degree corresponds to an amount of parallax of approximately 2.9% of the screen width.

FIGS. 8 and 9 are schematic diagrams illustrating the amount of parallax. FIG. 8 shows the positive projecting side, and FIG. 9 shows the negative projecting side.

When the parallax angle is 1 degree, the fact that this parallax angle corresponds to an amount of parallax of approximately 2.9% of the screen width will be described through reference to FIGS. 8 and 9.

For example, with a 50-inch display having an aspect ratio of 16:9, when a worker watches a stereoscopic image from a viewing distance that is three times the screen height, if we assume that the stereo base is 50 mm, then we obtain the following:

width: 1105 mm

height: 622 mm

viewing distance: 1866 mm=width×0.49/0.87×3

If we focus on the triangle formed when the amount of parallax (β) on the screen in FIG. 8 is moved in parallel to be adjacent to the stereo base, we obtain the following:

$$\begin{matrix}amount of parallax ( β ) = 2 \times tan ( β / 2 ) \times viewing distance - \\ stereo base \\ = 2 \times tan ( β / 2 ) \times viewing distance - \\ 2 \times tan ( θ / 2 ) \times viewing distance \\ = 2 \times viewing distance \times \\ ( tan ( β / 2 ) - tan ( θ / 2 ) )\end{matrix}$$

Using a trigonometric function addition theorem to calculate tan(θ/2), we obtain the following:

(tan(62 /2)−tan(θ/2))=(tan(β/2−θ/2)×(1+tan(β/2)×tan(θ/2))

β=θ+1 degree

tan(θ/2)=25/1866

Since tan(θ/2) is an extremely small value, if we approximate as:

(tan(β/2)−tan(θ/2))=tan(½ degree)=0.008727,

we can approximate as:

$$\begin{matrix}amount of parallax ( β ) = 2 \times viewing distance \times 0.008727 \\ = width \times 0.02949\end{matrix}$$

Therefore, the amount of parallax (β) for a parallax angle of 1 degree corresponds to approximately 2.9% of the screen width. Similarly, the negative projecting side will be described through reference to FIG. 9.

If we focus on the triangle formed when the two sides of a triangle with an angle of a move in parallel and the apex is in the screen plane, we obtain the following:

$$\begin{matrix}amount of parallax ( α ) = stereo base - 2 \times tan ( α / 2 ) \times \\ viewing distance \\ = 2 \times tan ( θ / 2 ) \times viewing distance - \\ 2 \times tan ( α / 2 ) \times viewing distance \\ = 2 \times viewing distance \times \\ ( tan ( θ / 2 ) - tan ( α / 2 ) )\end{matrix}$$

Using a trigonometric function addition theorem to calculate tan(θ/2), we obtain the following:

(tan(θ/2)−tan(α/2))=(tan(θ/2−α/2)×(1+tan(θ/2)×tan(α/2))

θ=α+1 degree

tan(θ/2)=25/1866

Since tan(θ/2) is an extremely small value, if we approximate as:

(tan(θ/2)−tan(α/2))=tan(½ degree)=0.008727

we can approximate as:

$$\begin{matrix}amount of parallax ( α ) = 2 \times viewing distance \times 0.008727 \\ = width \times 0.02949\end{matrix}$$

Therefore, the amount of parallax (α) for a parallax angle of 1 degree corresponds to approximately 2.9% of the screen width. Similarly, the amount of parallax for a parallax angle of 2 degrees corresponds to approximately 5.9% of the screen width.

The depth parallax is expressed by d in FIG. 7, and d is 50 mm or less, for example. What percentage of the screen width this 50 mm corresponds to varies with the screen size being displayed. It corresponds to approximately 4.5% with a 50-inch screen, to approximately 2.9% with a 77-inch screen, and to approximately 1.5% with a 150-inch screen. Therefore, the condition of taking into account the display size to be viewed by the worker (this corresponds to the “specific condition”) must be set ahead of time.

The above is just one guideline that has been proposed based on the correlation between excessive parallax and fatigue or unnaturalness, so a parallax angle of 1 degree or less is not necessarily a requirement. For instance, if the settings are to be made more on the safe side, the positive projecting-side parallax may be 1% or less of the screen width, the negative projecting-side parallax may be 2% or less of the screen width, and the depth parallax at the assumed display size may be 45 mm or less.

In the midst of this, there are increasing opportunities to use a computer to process and edit images captured with a 3D camera. For example, a stereoscopic image is processed and edited by using a mouse or other input device to control a cursor. If the cursor image is merely displayed so that it is superimposed over the stereoscopic image, then when work is performed while looking at the screen in 3D, it can be difficult to tell which part of the image the cursor is pointing at since the depth of the cursor is fixed.

In response to this problem, Japanese Laid-Open Patent Application 2001-326947 discloses a technique for adding to a cursor the same amount of parallax as that of the image portion at the location indicated by the cursor, when a cursor image is merged over a stereoscopic image. With this technique, it is stated that even when a stereoscopic image is being watched in 3D, it is easy to tell what portion of the stereoscopic image the cursor is pointing at. Also, Japanese Laid-Open Patent Application 2011-134295 discloses a technique with which, when a cursor image is merged over a stereoscopic image, the same amount of parallax is added to the cursor as that of the image portion at the location indicated by the cursor, and while the cursor is moving, the amount of parallax is fixed, regardless of the amount of parallax of the image portion at the location indicated by the cursor. With this technique, it is stated that it will be extremely rare for a worker to lose track of the cursor.

However, with the techniques discussed in Japanese Laid-Open Patent Application 2001-326947 and Japanese Laid-Open Patent Application 2011-134295, the amount of parallax of the image portion at the location indicated by the cursor is added to the cursor when the cursor has been stopped. For example, if the amount of parallax of the image portion at the location indicated by the cursor is too large, then an excessive amount of parallax will also end up being added to the merged cursor. Accordingly, when the worker uses the cursor to process or edit the image, the worker can become fatigued and the image can look unnatural.

### SUMMARY

The cursor merging device disclosed herein is a device for merging a cursor image with a subject-use stereoscopic image including left and right images. This cursor merging device comprises a two-dimensional position input component, an image parallax detector, a proper parallax range determination component, a cursor parallax production component, a cursor stereoscopic image production component, and a cursor stereoscopic image merging component. The two-dimensional position input component is configured to input cursor position information. The image parallax detector is configured to detect subject-use parallax information about the subject-use stereoscopic image indicated by the cursor position information. The proper parallax range determination component is configured to set a proper parallax range, which is the proper range for parallax, according to a specific condition. The cursor parallax production component is configured to set cursor parallax information so that the parallax of a cursor is included in the proper parallax range, on the basis of the subject-use parallax information. The cursor stereoscopic image production component is configured to produce a cursor-use stereoscopic image on the basis of the cursor parallax information. The cursor stereoscopic image merging component is configured to merge the cursor-use stereoscopic image included in the proper parallax range with the subject-use stereoscopic image.

With this cursor merging device, when a worker is processing and editing images, the worker does not become fatigued and the images do not look unnatural. More precisely, with this cursor merging device, the amount of parallax of the cursor can be kept to within the proper parallax range even if the cursor points to a portion of the image with an excessive amount of parallax. Accordingly, when the worker performs processing or editing, the worker does not become fatigued and the image does not look unnatural.

Also, with this cursor merging device, information related to the amount of parallax of the image indicated by the cursor can be more clearly displayed, which makes it easier for the worker to perform processing and editing.

Also, with this cursor merging device, the processing and editing of a stereoscopic image can be more easily carried out by the worker even in two-dimensional image display mode.

Also, with this cursor merging device, even when an image is being processed and edited while the worker is viewing this image in two-dimensional left/right image mixed display mode, it still is possible to display the cursor so that it is easy to tell which portion of the image the cursor is pointing at.

### BRIEF DESCRIPTION OF THE DRAWINGS

Referring now to the attached drawings, which form a part of this original disclosure:

FIG. 1 is a block diagram of the configuration of a cursor merging device in Embodiment 1;

FIG. 2A is a schematic diagram of a stereoscopic image;

FIG. 2B is a schematic diagram of a stereoscopic image;

FIG. 3A is a schematic diagram illustrating the operation of the cursor merging device in Embodiment 1;

FIG. 3B is a schematic diagram illustrating the operation of the cursor merging device in Embodiment 1;

FIG. 4 is a block diagram of the configuration of a cursor merging device in Embodiment 2;

FIG. 5A is a schematic diagram illustrating the operation of the cursor merging device in Embodiment 2;

FIG. 5B is a schematic diagram illustrating the operation of the cursor merging device in Embodiment 2;

FIG. 6A is a schematic diagram illustrating the principle behind a stereoscopic image;

FIG. 6B is a schematic diagram illustrating the principle behind a stereoscopic image;

FIG. 6C is a schematic diagram illustrating the principle behind a stereoscopic image;

FIG. 7 is a schematic diagram illustrating the parallax angle and depth parallax;

FIG. 8 is a schematic diagram illustrating the amount of parallax on the positive projecting side; and

FIG. 9 is a schematic diagram illustrating the amount of parallax on the negative projecting side.

### DETAILED DESCRIPTION OF EMBODIMENTS

Selected embodiments of the present technology will now be explained with reference to the drawings. It will be apparent to those skilled in the art from this disclosure that the following descriptions of the embodiments of the present technology are provided for illustration only and not for the purpose of limiting the technology as defined by the appended claims and their equivalents.

### First Embodiment

The cursor merging device in an embodiment will now be described in detail through reference to the drawings.

1. Configuration of Cursor Merging Device

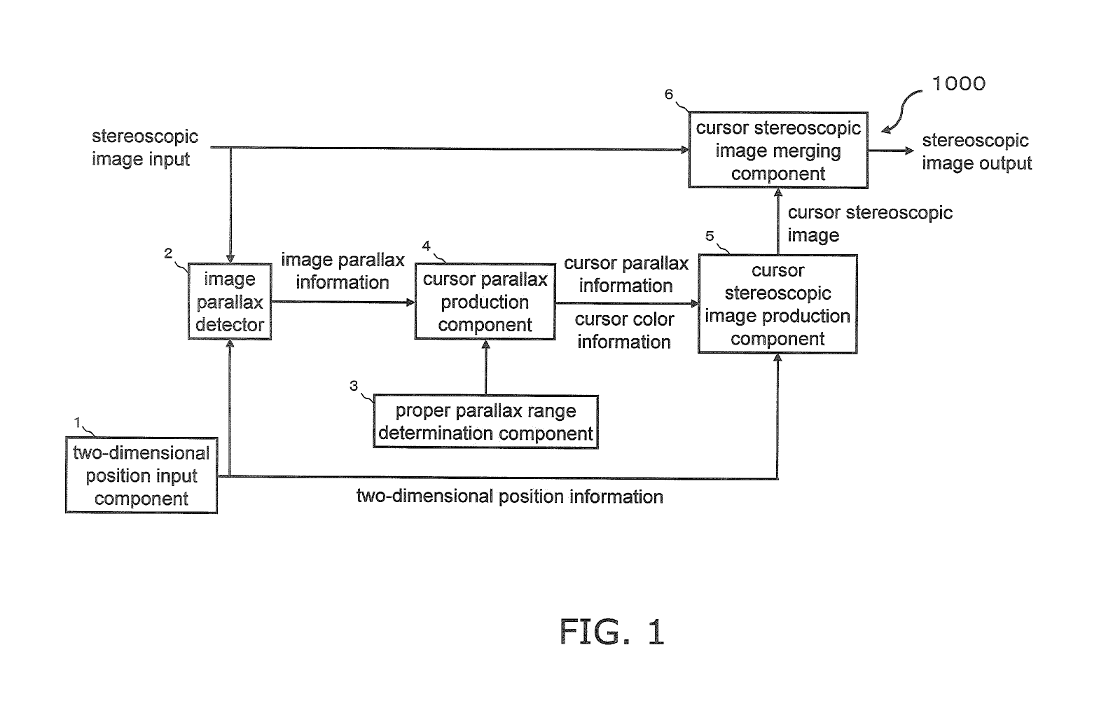

FIG. 1 is a block diagram of the configuration of a cursor merging device 1000 in Embodiment 1. As shown in FIG. 1, the cursor merging device 1000 is constituted by a two-dimensional position input component 1, an image parallax detector 2, a proper parallax range determination component 3, a cursor parallax production component 4, a cursor stereoscopic image production component 5, and a cursor stereoscopic image merging component 6.

The two-dimensional position input component 1 is constituted by a computer mouse, a track ball, a coordinate input device, or the like, for example. The two-dimensional position input component 1 is an interface that the worker uses to specify the two-dimensional position of the stereoscopic image. The two-dimensional position information that is the output of the two-dimensional position input component 1 is outputted to the image parallax detector 2 and the cursor stereoscopic image production component 5.

The image parallax detector 2 detects parallax information about a stereoscopic image signal for the two-dimensional position specified with the two-dimensional position input component 1, and outputs this as image parallax information (an example of subject-use parallax information) to the cursor parallax production component 4.

The proper parallax range determination component 3 calculates information about the proper range for the amount of parallax (proper parallax range information) according to a predetermined setting related to a proper parallax range determination standard, and outputs the proper parallax range information to the cursor parallax production component 4. The “setting related to a proper parallax range determination standard” is information used to define, for example, the size of the 3D monitor used by a worker, the standard for suppressing parallax, the color of the cursor corresponding to the state of parallax, and so forth. Thus, the proper parallax range is set according to the setting related to a proper parallax range determination standard (an example of a specific condition).

The cursor parallax production component 4 performs suppression control on image parallax information about the cursor position, on the basis of proper parallax range information, and outputs the result as cursor parallax information. At the same time, the cursor parallax production component 4 outputs cursor color information that matches the situation of the outputted cursor parallax information. For example, if cursor parallax information has been suppressed in the negative projecting direction, red cursor color information is outputted, and if cursor parallax information has not been suppressed in the negative projecting direction, orange cursor color information is outputted. Also, if the amount of cursor parallax is at the reference plane position, green cursor color information is outputted. If the amount of cursor parallax has not been suppressed in the positive projecting direction, blue cursor color information is outputted, and if the amount of cursor parallax has been suppressed in the positive projecting direction, purple cursor color information is outputted. These colors and types can be set ahead of time to suit the individual preferences of the worker. These colors and types may also be set automatically.

The cursor stereoscopic image production component 5 produces a cursor image for the left-eye image and a cursor image for the right-eye image on the basis of the two-dimensional position information outputted by the two-dimensional position input component 1, and the cursor color information and cursor parallax information of the cursor parallax production component 4. And the cursor stereoscopic image production component 5 outputs these two cursor images as a cursor stereoscopic image. The cursor stereoscopic image merging component 6 merges the cursor stereoscopic image with the stereoscopic image, and outputs the result.

2. Operation of Cursor Merging Device

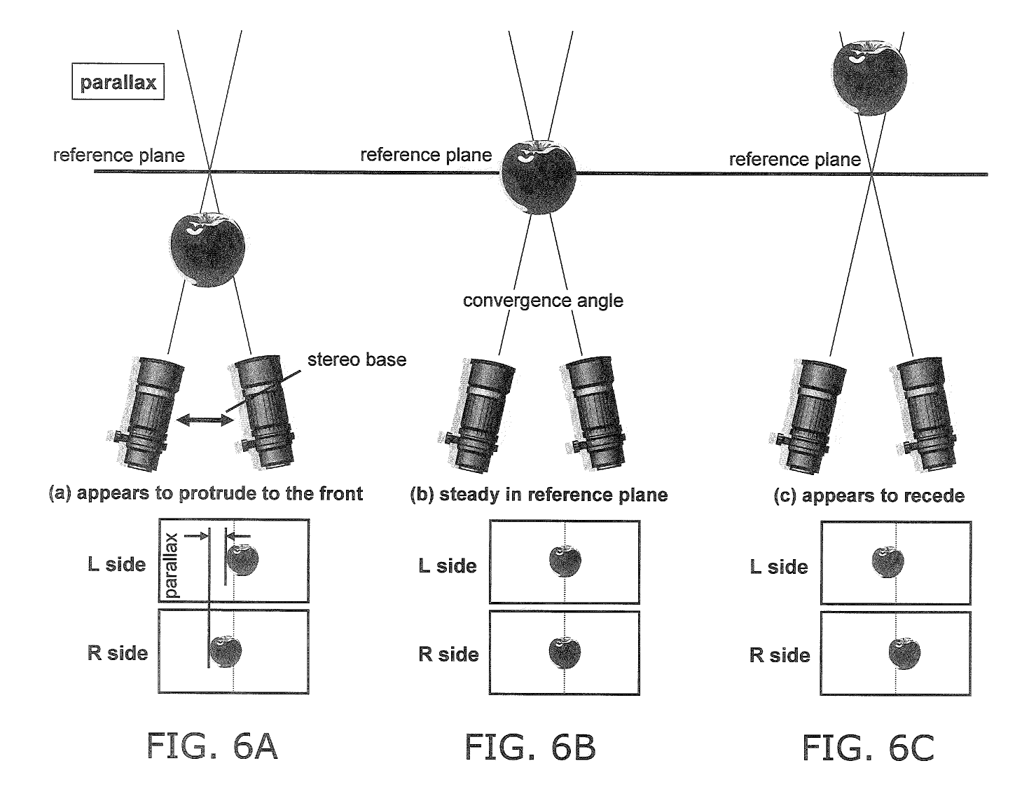

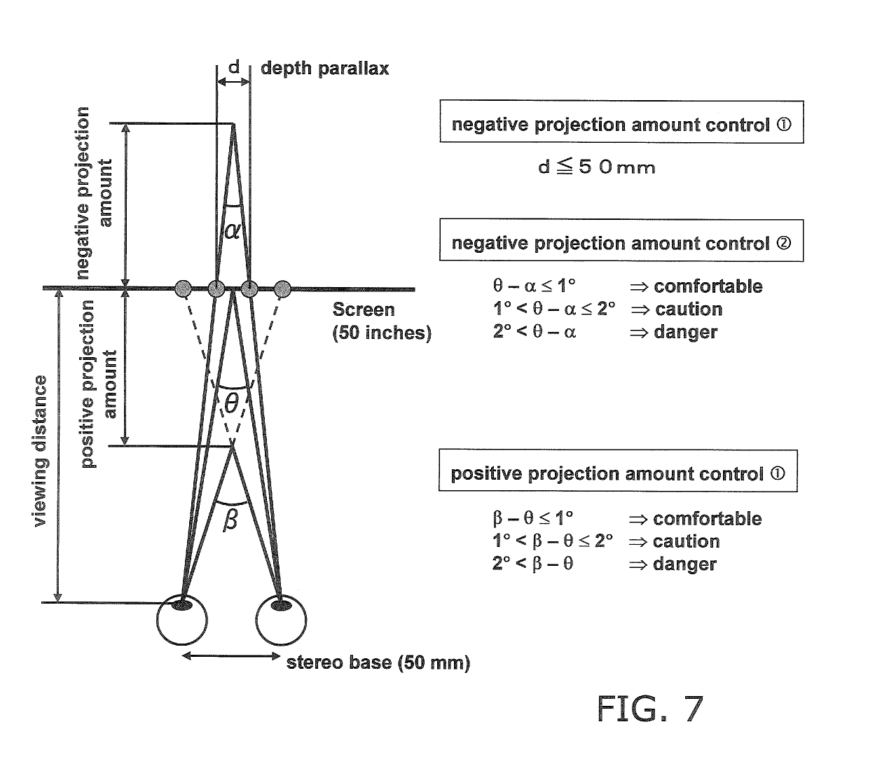

The operation and effect of the cursor merging device 1000 will be described in detail through reference to FIGS. 1 to 8.

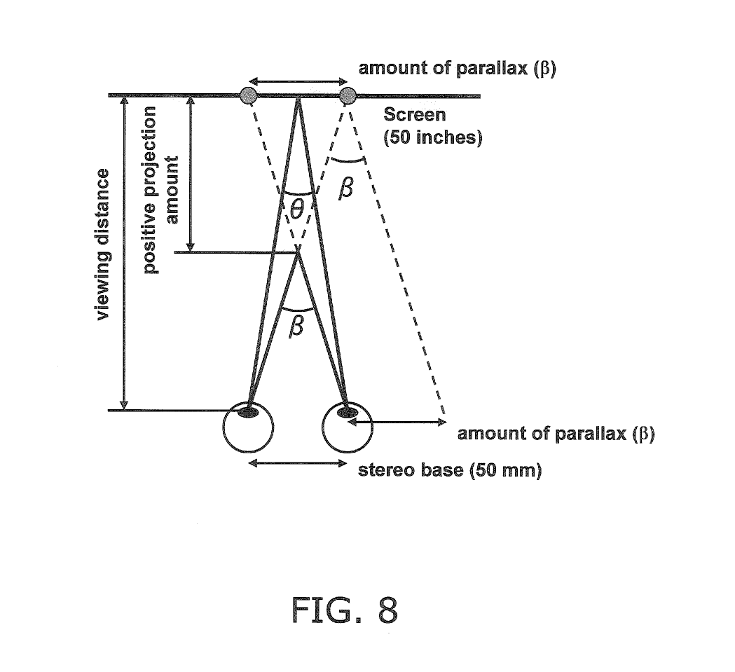

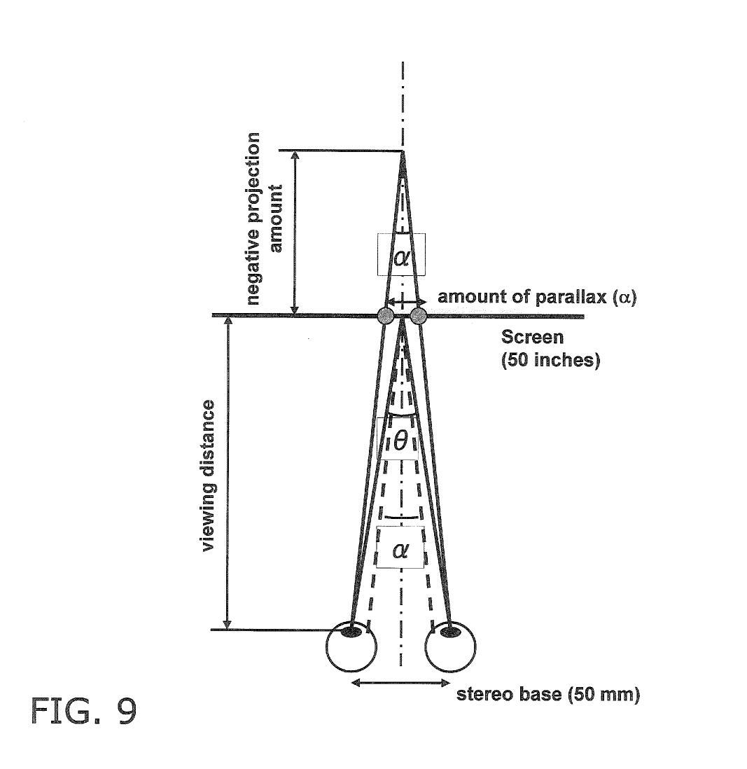

Here, as an example, the display size is assumed to be 50 inches and the stereo base 50 mm, under the conditions of the 3D Consortium Safety Guidelines. On the positive projecting side, a parallax of from 0% up to 2.9% of the screen width is assumed to be the comfortable region, from 2.9 to 5.9% the caution region, and over 5.9% the danger region. On the negative projecting side, a parallax of from 0% up to 2.9% of the screen width is assumed to be the comfortable region, from 2.9 to 4.5% the caution region, and over 4.5% the danger region. The specific condition discussed above through reference to FIGS. 8 and 9 is set so as to fall in these regions. The amount of parallax of the cursor image is suppressed so that the amount of parallax of the cursor image is not in the danger region. More specifically, the amount of parallax of the cursor image is clipped if it is over 5.9% on the positive projecting side and if it is over 4.5% on the negative projecting side.

Specific color information is set for the cursor color information according to the region that has been clipped. For instance, if the amount of parallax of the cursor image has been clipped in the negative projecting direction, the cursor color information is set to red. If the amount of parallax of the cursor image is in the caution region in the negative projecting direction, the cursor color information is set to orange. If the amount of parallax of the cursor image is in the comfortable region in the negative projecting direction, the cursor color information is set to yellow-green. If the amount of parallax of the cursor image is near the reference plane (a specific region that includes the reference plane), the cursor color information is set to green.

If the amount of parallax of the cursor image is in the comfortable region in the positive projecting direction, the cursor color information is set to light blue. If the amount of parallax of the cursor image is in the caution region in the positive projecting direction, the cursor color information is set to blue. If the amount of parallax of the cursor image has been clipped in the positive projecting direction, the cursor color information is set to purple.

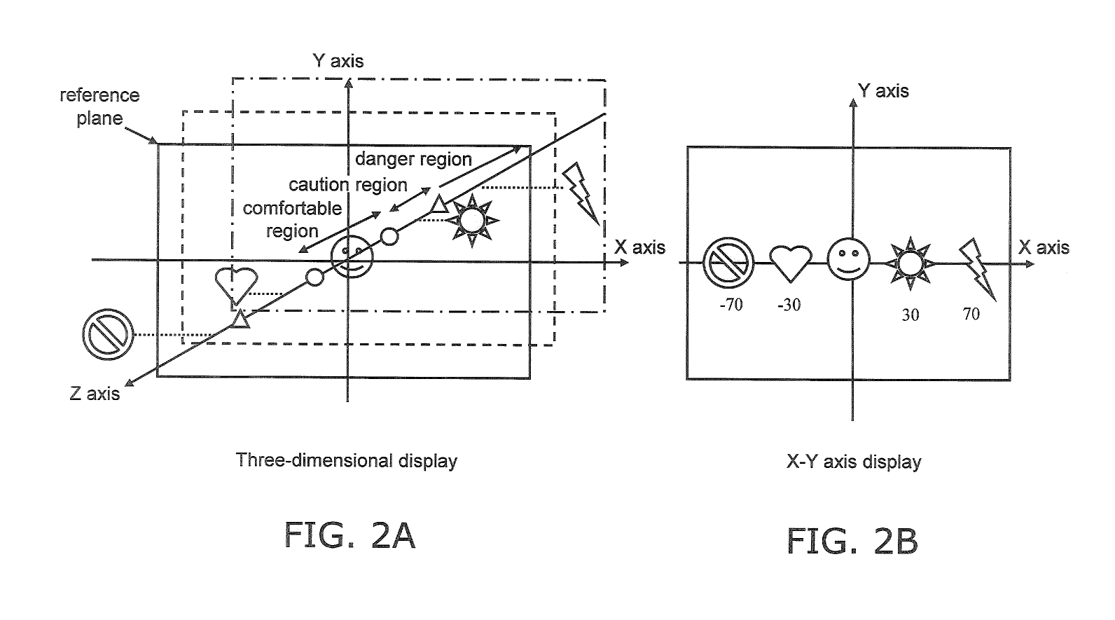

FIG. 2A and FIG. 2B is a schematic diagram of a stereoscopic image. FIG. 2A shows a three-dimensional display, and FIG. 2B shows a two-dimensional display along the X-Y axes.

In FIG. 2A and FIG. 2B, two-dimensional position coordinates are represented by the X axis and Y axis, and the depth coordinate is represented by the Z axis. The stereoscopic image is expressed by the X axis , the Y axis, and the Z axis. The proper parallax range is set ahead of time, using the portion of the Z axis between the reference plane position and ◯ as the comfortable region for parallax, between ◯ and Δ as the caution region for parallax, and outward beyond Δ as the danger region for parallax. As shown in FIG. 2b, the symbol for “prohibited,” a heart symbol, a smiley face, a sun symbol, and a lightning bolt symbol are arranged in that order starting from the left, at the middle height. As shown in FIG. 2a, the “prohibited” symbol is disposed in the danger region for parallax on the positive projecting side, the heart symbol in the caution region on the positive projecting side, the smiley face in the comfortable region (reference plane), the sun symbol in the caution region on the negative projecting side, and the lightning bolt symbol in the danger region on the negative projecting side.

The rectangle in the drawing represents the reference plane and two types of screen frame on the negative projecting side. Specifically, the rectangle drawn with solid lines represents the screen frame of the reference plane, the rectangle drawn with a dashed line represents the screen frame in the caution region on the negative projecting side, and the one-dot chain line represents the screen frame in the danger region on the negative projecting side. The smiley face is disposed in the solid line rectangle of each reference plane, the sun symbol in the dashed line rectangle in the danger region on the negative projecting side, and the lightning bolt symbol in the one-dot chain line rectangle in the danger region on the negative projecting side.

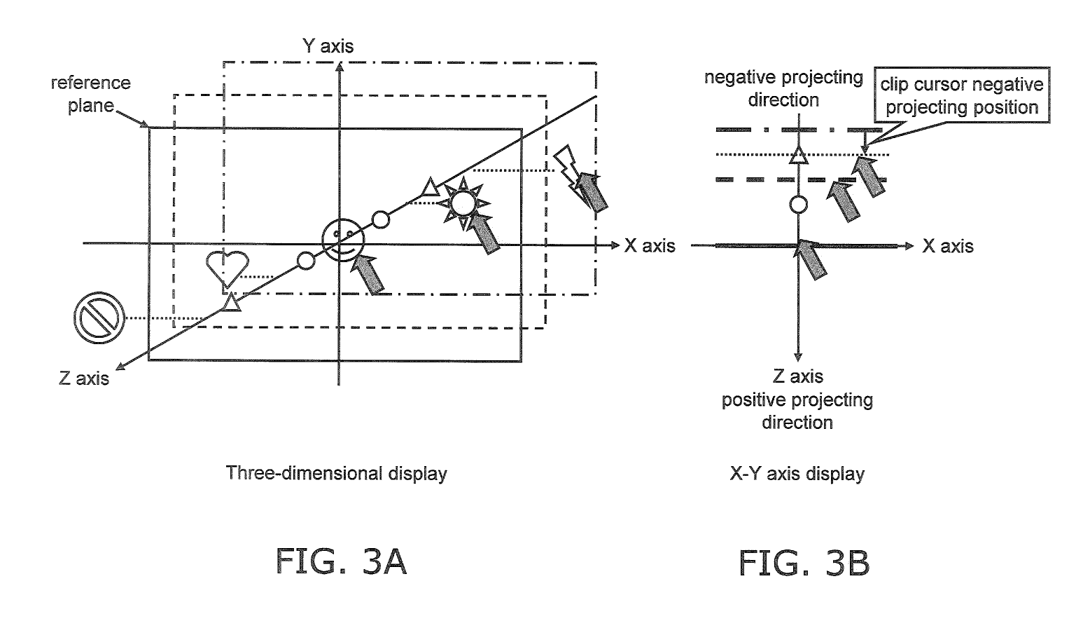

FIG. 3 is a schematic diagram illustrating the operation of the cursor merging device in Embodiment 1.

The operation when the stereoscopic image in FIG. 2 is inputted to the cursor merging device of Embodiment 1 will be described through reference to FIGS. 2 and 3.

First, the two-dimensional position of the cursor in the X-Y axis plane is inputted with a mouse or the like of the two-dimensional position input component 1. If the two-dimensional position inputted here is the center of the screen in FIG. 2b, that is, the position of the smiley face ((X,Y)=(0,0)), then the image parallax detector 2 detects the parallax of the image at the inputted two-dimensional position, that is, the parallax of the smiley face image.

Any method may be used to detect image parallax, so long as the amount of parallax can be detected. For example, the two-dimensional position in right-eye image data is detected by comparing the right-eye image data with the left-eye image data around the inputted two-dimensional position, and the deviation between the left-eye position and the right-eye position is detected as the amount of parallax.

In this case, if parallax in the smiley face image is detected from the left and right images, the detected amount of parallax is zero, which is obvious since the smiley face is in the reference plane.

The cursor parallax production component 4 performs clipping on the detected image parallax information (zero in this case) by using information from the proper parallax range determination component 3.

For example, if the proper parallax range is less than 5.9% on the positive projecting side and less than 4.5% on the negative projecting side, and the image parallax information is zero, then the clipped cursor parallax information has the same value as the detected image parallax information (zero). In this embodiment, clipping is executed even when the image parallax information is included in the proper parallax range.

The cursor parallax production component 4 outputs a parallax amount of zero as the cursor parallax information, and outputs green as the cursor color information. In this case, the cursor color information is green since the parallax of the smiley face is near the reference plane. The cursor stereoscopic image production component 5 produces a stereoscopic image of a green cursor having zero parallax at the position of (X,Y)=(0,0) based on the two-dimensional position information (X,Y)=(0,0), the cursor parallax information (zero parallax), and the cursor color information (green). The cursor stereoscopic image production component 5 outputs this stereoscopic image to the cursor stereoscopic image merging component 6. The cursor stereoscopic image merging component 6 then merges this cursor stereoscopic image with the original stereoscopic image and outputs the result.

It appears to the worker watching the stereoscopic image on a 3D monitor that the merged cursor is located in the reference plane because the parallax is zero. Specifically, a cursor having the same sense of depth as the smiley face, which is the image at the position indicated by the worker, is automatically displayed.

Then, the two-dimensional position input component 1 shifts the position of the cursor in the X axis direction within the X-Y plane, and moves the cursor to the position (X,Y)=(30,0) of the sun symbol.

Similarly, the image parallax detector 2 detects the parallax of the sun symbol image. The cursor parallax production component 4 executes clipping and sets cursor parallax information on the basis of information from the proper parallax range determination component 3. Since the sun symbol is in the caution region on the negative projecting side, the cursor parallax information has the same value as the detected parallax information for the sun symbol image.

In this case, since the parallax of the sun symbol is in the caution region on the negative projecting side, the cursor color information is orange for the caution region on the negative projecting side.

Specifically, the same amount of parallax as that of the sun symbol is outputted as cursor parallax information, and orange is outputted as cursor color information.

The cursor stereoscopic image production component 5 produces a stereoscopic image of an orange cursor having the same amount of parallax as the sun symbol at the position of (X,Y)=(30,0) based on the two-dimensional position information (X,Y)=(30,0), the cursor parallax information (the same amount of parallax as the sun symbol), and the cursor color information (orange). The cursor stereoscopic image production component 5 outputs this stereoscopic image to the cursor stereoscopic image merging component 6. The cursor stereoscopic image merging component 6 then merges this stereoscopic image of the cursor with the original stereoscopic image, and outputs the result.

It appears to the worker watching the stereoscopic image on a 3D monitor that the merged cursor is at the same depth as the sun symbol, and points to the sun symbol in orange. Specifically, a cursor having the same sense of depth as the sun symbol, which is the image at the position indicated by the worker, is automatically displayed.

Then, the two-dimensional position input component 1 shifts the position of the cursor in the X axis direction within the X-Y plane, and moves the cursor to the position (X,Y)=(70,0) of the lightning bolt symbol.

Similarly, the image parallax detector 2 detects the parallax of the lightning bolt symbol image, and the cursor parallax production component 4 executes clipping and sets cursor parallax information on the basis of information from the proper parallax range determination component 3. Since the lightning bolt symbol is in the danger region on the negative projecting side, the amount of parallax of the cursor is suppressed (clipped) all the way to the boundary value between the danger region and the caution region on the negative projecting side. The amount of parallax of the cursor after this clipping is the cursor parallax information.

In this case, since the parallax of the lightning bolt symbol is in the caution region on the negative projecting side, the cursor color information is red for performing suppression on the negative projecting side.

Specifically, the cursor parallax production component 4 outputs red as the cursor color information, and outputs the boundary value between the danger region and the caution region on the negative projecting side as the cursor parallax information.

The cursor stereoscopic image production component 5 produces a stereoscopic image of a red cursor having a parallax amount at the boundary between the caution region and the danger region, at the position of (X,Y)=(70,0) based on the two-dimensional position information (X,Y)=(70,0), the cursor parallax information (boundary parallax amount between caution region and danger region), and the cursor color information (red). The cursor stereoscopic image production component 5 outputs this stereoscopic image to the cursor stereoscopic image merging component 6. The cursor stereoscopic image merging component 6 then merges this cursor stereoscopic image with the original stereoscopic image and outputs the result.

A cursor pointing to the lightning bolt symbol is displayed in red in front of the boundary between the caution region and the danger region, that is, the lightning bolt symbol image, for the worker watching the stereoscopic image on a 3D monitor.

FIG. 3A and FIG. 3B shows how cursors are displayed for this series of movements. FIG. 3A shows a three-dimensional display, while FIG. 3B shows the depth position on the X-Z axis.

When the processing discussed above is executed, if the image indicated by a cursor does not have excessive parallax, a stereoscopic image of the cursor is displayed with the same sense of depth as the image of the cursor position. On the other hand, if the image indicated by the cursor have excessive parallax, then a stereoscopic image of the cursor is displayed so that excessive parallax does not occur in the cursor. Thus, this technique is characterized by a point in that excessive parallax can be automatically suppressed so that excessive parallax is not generated on the stereoscopic image of a cursor. As a result, when a worker is processing and editing a stereoscopic image, there will be less fatigue and image unnaturalness.

Furthermore, information related to the amount of parallax of the portion of the image indicated by the cursor can be more distinctively displayed by presenting the information as cursor color information. Accordingly, a cursor merging device can be obtained with which it is easier for the worker to carry out processing and editing.

Specifically, when the amount of parallax of the portion of an image indicated by the cursor is excessive, an excessive amount of parallax is also added to the merged cursor, and this solves the problem of increased fatigue or unnaturalness when a worker performs processing and editing.

3. Conclusion

The cursor merging device 1000 pertaining to this embodiment is a device that merges a cursor image with a stereoscopic image including left and right images. The cursor merging device 1000 comprises the two-dimensional position input component 1, the image parallax detector 2, the proper parallax range determination component 3, the cursor parallax production component 4, the cursor stereoscopic image production component 5, and the cursor stereoscopic image merging component 6. Consequently, when a worker is watching an image in 3D, it become easy to tell which portion of the image the cursor is pointing at. Also, even if the amount of parallax of the portion of the image indicated by the cursor is excessive, the amount of parallax of the cursor can be automatically reduced to a proper range, so the worker can experience less fatigue and the image looks more natural. And since information related to the amount of parallax of the portion of the image indicated by the cursor can be more distinctively conveyed by the color of the cursor, the worker can carry out processing and editing more easily.

Any method may be used to detect image parallax, so long as the amount of parallax can be detected. With a parallax detection method involving comparison of images, the left-eye image region being compared may be fixed, or the size of the region may be varied as needed, on the basis of the result of image recognition of the left-eye image, etc.

Also, the search region in the left-eye image being compared may be fixed, or it may be varied according to the size of the left-eye image region being compared, etc.

Also, it was assumed that the conditions for determining the proper parallax range were the conditions of the 3D Consortium Safety Guidelines, the display size was 50 inches, and the stereo base was 50 mm, and the image was classified into three regions (the comfortable region, the caution region, and the danger region), but the present technology is not limited to this.

Also, there were seven different cursor colors, but the present technology is not limited to this.

Also, the cursor shape can be modified just as when the cursor color was modified as discussed above. For example, just as with cursor color information, cursor shape information can be used, in which case cursor shape information in which the amount of parallax of the image corresponds to the various regions (comfortable region, caution region, and danger region) is prepared for the positive projecting side and the negative projecting side, which allows the shape of the cursor to be modified in the various regions. Also, modification of the cursor color and modification of the cursor shape may be executed either separately or simultaneously.

### Second Embodiment

1. Configuration of Cursor Merging Device

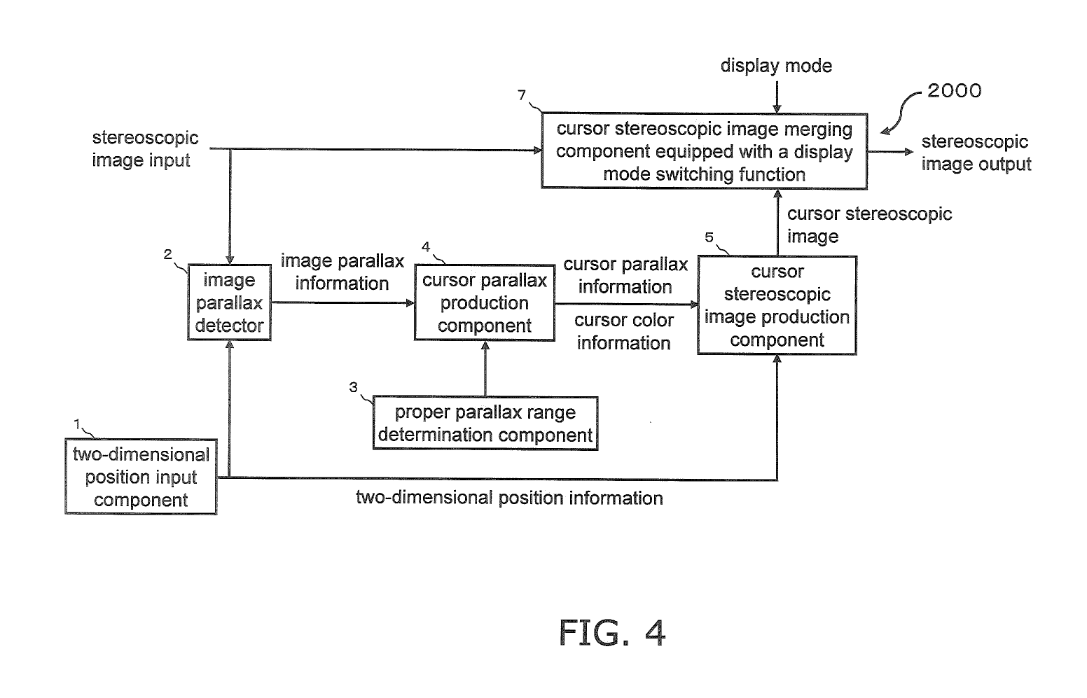

FIG. 4 is a block diagram of the configuration of a cursor merging device 2000 in Embodiment 2.

As shown in FIG. 4, the cursor merging device 2000 is constituted by a two-dimensional position input component 1, an image parallax detector 2, a proper parallax range determination component 3, a cursor parallax production component 4, a cursor stereoscopic image production component 5, and a cursor stereoscopic image merging component 7 equipped with a display mode switching function. In FIG. 4, blocks that are the same as in Embodiment 1 are numbered the same.

What is different from Embodiment 1 is that the cursor stereoscopic image merging component 6 is changed to the cursor stereoscopic image merging component 7 equipped with a display mode switching function.

When a stereoscopic image is processed and edited, the worker performs a job while viewing an image that has depth as a stereoscopic image, or closely checks only a left- or right-eye image as a two-dimensional image, or checks the deviation in an image as a two-dimensional image by mixing the left-eye image and right-eye image. The worker thus views the image in a variety of display modes.

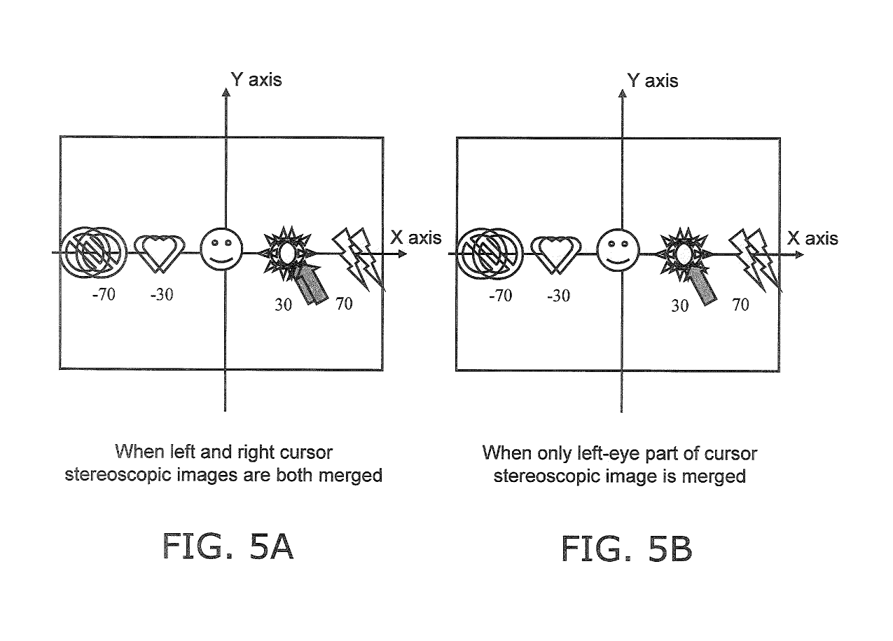

Of these various display modes, when the worker checks the deviation in an image as a two-dimensional image by mixing the left-eye image and right-eye image, a problem is that the cursor ends up be displayed double (see FIG. 5a), or that it is difficult to tell which portion of the image the cursor is pointing at.

Embodiment 2 of the present technology solves the above problems, and the cursor stereoscopic image merging component 7 equipped with a display mode switching function is a cursor merging device that switches the cursor merging operation according to the display mode in which the worker is viewing the screen while processing and editing.

2. Operation of Cursor Merging Device

The operation of the cursor merging device 2000 in Embodiment 2 of the present technology constituted as above, as well as how the operation differs from that in Embodiment 1, will be described in detail through reference to FIG. 5.

FIG. 5 illustrates the cursor merging operation in Embodiment 2. FIG. 5 is a schematic diagram in which left- and right-eye images are mixed to form a two-dimensional image. FIG. 5a shows when the left and right sides of a cursor stereoscopic image are merged, and FIG. 5b shows the situation in Embodiment 2.

The cursor stereoscopic image merging component 7 equipped with a display mode switching function merges the cursor stereoscopic image with both the left and right sides of the original stereoscopic image when the display mode is 3D mode. On the other hand, when the display mode is two-dimensional left and right image mixing mode, just the left-eye image of the cursor stereoscopic image is merged with the original stereoscopic image.

Let us now consider the merging of the cursor stereoscopic image with both the left and right sides of the original stereoscopic image (mixing the left and right images of a stereoscopic image) into a two-dimensional display, as in 3D mode. For example, when the cursor is pointing at the sun symbol, an orange cursor having the same amount of parallax as the sun symbol is merged with the left and right images. Specifically, since the sun symbol is in the caution region on the negative projecting side, the orange cursor has the amount of parallax of the caution region on the negative projecting side. That is, the right-eye cursor image is displayed more to the right side than the left-eye cursor image, and if the left-eye image is seen by just the left eye in 3D mode, and the right-eye image by just the right eye in 3D mode, then the difference between these left and right cursor displays is perceived by the brain as a sense of depth.

However, if the left-eye image and right-eye image in this state are merely mixed into a two-dimensional display, as shown in FIG. 5A, the cursor is displayed double, making it harder to see image the cursor is pointing at. In contrast, in two-dimensional left and right image mixing mode, when just the left-eye image of the stereoscopic image of the cursor is merged, as shown in FIG. 5B, the cursor is not displayed double, so the worker can more clearly see the image indicated by the cursor.

With this processing, in 3D mode, a worker can work while looking at a stereoscopic image with a merged cursor that gives a sense of depth. Meanwhile, in two-dimensional left and right image mixing mode, just the left-eye cursor is merged, so the cursor is not displayed double. Accordingly, the worker can more clearly tell which portion of the image the cursor is pointing at. The other blocks are the same as in Embodiment 1, and will therefore not be described again.

3. Conclusion

As discussed above, the cursor merging device 2000 pertaining to this embodiment is a cursor merging device that merges a cursor image with a stereoscopic image including left and right images. The cursor merging device 2000 comprises the two-dimensional position input component 1, the image parallax detector 2, the proper parallax range determination component 3, the cursor parallax production component 4, the cursor stereoscopic image production component 5, and the cursor stereoscopic image merging component 7 equipped with a display mode switching function. Consequently, when a worker is looking at an image three-dimensionally in 3D mode, it becomes easy to tell which portion of the image the cursor is pointing at. Also, even if the amount of parallax of the portion of the image the cursor is pointing at is excessive, the amount of parallax of the cursor can be automatically reduced to the proper range, so there becomes less worker fatigue or image unnaturalness. Also, since information related to the amount of parallax of the portion of the image the cursor is pointing at can be clearly conveyed by means of the cursor color, the worker can carry out processing and editing more easily. Furthermore, when an image is viewed in planar fashion in two-dimensional left and right image mixing mode, double display of the cursor can be prevented, and which portion of the image the cursor is pointing at can be seen more clearly.

An example was given in which the left-eye image of a cursor stereoscopic image was used for the cursor image merged in two-dimensional left and right mixing mode, but the right-eye image of a cursor stereoscopic image may instead be used as the cursor image. Also, a single cursor image may be produced on the basis of the left-eye image of a cursor stereoscopic image and the right-eye image of a cursor stereoscopic image, and this cursor image may be used.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the cursor merging device and the cursor merging method. Accordingly, these terms, as utilized to describe the present technology should be interpreted relative to the cursor merging device and the cursor merging method.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technology are provided for illustration only, and not for the purpose of limiting the technology as defined by the appended claims and their equivalents.

### INDUSTRIAL APPLICABILITY

The present technology can be widely applied to cursor merging devices and cursor merging methods.

What is claimed is:

1. A cursor merging device for merging a cursor image with a subject-use stereoscopic image, the subject-use stereoscopic including left and right images, the cursor merging device comprising:
a two-dimensional position input component configured to input cursor position information;
an image parallax detector configured to detect subject-use parallax information about the subject-use stereoscopic image indicated by the cursor position information;
a proper parallax range determination component configured to set a proper parallax range, which is the proper range for parallax, according to a specific condition;
a cursor parallax production component configured to set cursor parallax information so that the parallax of a cursor is included in the proper parallax range, on the basis of the subject-use parallax information;
a cursor stereoscopic image production component configured to produce a cursor-use stereoscopic image on the basis of the cursor parallax information; and
a cursor stereoscopic image merging component configured to merge the cursor-use stereoscopic image included in the proper parallax range with the subject-use stereoscopic image.

2. The cursor merging device according to claim 1, wherein:
the cursor parallax production component sets the cursor parallax information so that the cursor parallax is included inside the proper parallax range if the subject-use parallax is included outside the proper parallax range.

3. The cursor merging device according to claim 1, wherein:
the cursor parallax production component changes the color of the cursor-use stereoscopic image according to how the cursor parallax information has been set.

4. The cursor merging device according to claim 1, wherein:
the cursor parallax production component changes the shape of the cursor-use stereoscopic image according to a setting status of the cursor parallax information.

5. A cursor merging device for merging a cursor image with a subject-use stereoscopic image, the subject-use stereoscopic including left and right images, the cursor merging device comprising:
a two-dimensional position input component configured to input cursor position information;
an image parallax detector configured to detect subject-use parallax information about the subject-use stereoscopic image indicated by the cursor position information;
a proper parallax range determination component configured to set a proper parallax range, which is the proper range for parallax, according to a specific condition;
a cursor parallax production component configured to set cursor parallax information so that the parallax of a cursor is included in the proper parallax range, on the basis of the subject-use parallax information;
a cursor stereoscopic image production component configured to produce a cursor-use stereoscopic image on the basis of the cursor parallax information; and
a cursor stereoscopic image merging component configured to import a display mode and merge the cursor image with an image corresponding to the display mode, according to the display mode.

6. The cursor merging device according to claim 5, wherein:
if the display mode is a mode in which left and right images are superposed and displayed, the cursor stereoscopic image merging component uses at least one of the left image-use cursor image and the right image-use cursor image to merge the cursor image with the left and right images.

7. The cursor merging device according to claim 5, wherein:
the cursor stereoscopic image merging component merges the cursor-use stereoscopic image with the subject-use stereoscopic image if the display mode is a mode in which a stereoscopic image is displayed.

8. A cursor merging method for merging a cursor image with a subject-use stereoscopic image, the subject-use stereoscopic image being including left and right images, the cursor merging method comprising:
inputting cursor position information;
detecting subject-use parallax information about the subject-use stereoscopic image indicated by the cursor position information;
setting a proper parallax range, which is the proper range for parallax, according to a specific condition;
setting cursor parallax information so that the parallax of a cursor is included in the proper parallax range, on the basis of the subject-use parallax information;
producing a cursor-use stereoscopic image on the basis of the cursor parallax information; and
merging the cursor-use stereoscopic image with the subject-use stereoscopic image.

9. The cursor merging method of claim 8, wherein:
the proper parallax range is set according to a plurality of specific conditions.

10. The cursor merging method of claim 8, wherein:
the merging the cursor-use stereoscopic image with the subject-use stereoscopic image includes importing a display mode and merging the cursor with an image corresponding to the display mode, according to the display mode.

11. The cursor merging method of claim 8, wherein:
the cursor-use stereoscopic image is included in the proper parallax range.
